(19) United States
(12) Patent Application Publication
(10) Pub. No.: US 2015/0179367 A1
(43) Pub. Date: Jun. 25, 2015

(54) SWITCH MANUFACTURING METHOD AND SWITCH

(71) Applicants: Atsushi KODAMA, Tokyo (JP); Toshihiko TERASHITA, Tokyo (JP); Yoichi YASUNAGA, Tokyo (JP); Hiroshi HIRAHATA, Tokyo (JP)

(72) Inventors: Atsushi KODAMA, Tokyo (JP); Toshihiko TERASHITA, Tokyo (JP); Yoichi YASUNAGA, Tokyo (JP); Hiroshi HIRAHATA, Tokyo (JP)

(73) Assignee: MITSUMI ELECTRIC CO., LTD., Tokyo (JP)

(21) Appl. No.: 14/573,015

(22) Filed: Dec. 17, 2014

(30) Foreign Application Priority Data
Dec. 19, 2013 (JP) 2013-263085
Jun. 30, 2014 (JP) 2014-134205
Nov. 7, 2014 (JP) 2014-227289

(51) Int. Cl. H01H 13/06; H01H 11/00

(52) U.S. Cl. CPC H01H 13/06; H01H 11/00; H01H 2229/048

(57) ABSTRACT

A manufacturing method for a switch includes steps of: arranging a plurality of fixed electrodes so as to be supported by a plurality of pins provided within a metal mold; molding a switch case integrally with the fixed electrodes by injecting a first resin into the metal mold; pulling out the pins to take out the switch case from the metal mold; filling a liquid-state second resin into through holes formed in the switch case as traces of removal of the pins; and curing the liquid-state second resin to form a protection portion.

### BACKGROUND

The invention relates to a method for manufacturing a switch to be mounted on electronic equipment or the like. Also, it relates to a switch to be mounted on electronic equipment or the like.

This type of switch has a resin-made switch case, multiple fixed electrodes and a movable electrode. The fixed electrodes are supported by the switch case. The movable electrode can be displaced according to the switch operation of a user to change the conduction state between the multiple fixed electrodes (for example, JP-A-2003-234040).

### SUMMARY

A switch to be mounted on electronic equipment is required to have high waterproof properties. It is an object of the invention to enhance the waterproof properties of such switch.

According to one aspect of the invention, there is provided a manufacturing method for a switch, comprising steps of:

arranging a plurality of fixed electrodes so as to be supported by a plurality of pins provided within a metal mold;

molding a switch case integrally with the fixed electrodes by injecting a first resin into the metal mold;

pulling out the pins to take out the switch case from the metal mold;

filling a liquid-state second resin into through holes formed in the switch case as traces of removal of the pins; and

curing the liquid-state second resin to form a protection portion.

The liquid-state second resin may be injected from a nozzle toward the through holes, and the liquid-state second resin may be cured within each of the through holes to form the protection portion.

An amount of injection of the liquid-state second resin may be determined so that a surface of the protection portion to be formed is situated within each of the through holes.

The second resin may be ultraviolet curing resin which is cured by irradiating ultraviolet rays thereto.

The second resin may be cured through secondary molding.

The second resin may be resin which, before cured, has higher fluidity than the first resin.

According to another aspect of the invention, there is provided a switch, comprising:

a switch case formed of a first resin;

a plurality of fixed electrodes supported by the switch case;

a movable electrode configured to change a conduction state between the fixed electrodes; and

a protection portion formed of a second resin,

wherein a plurality of through holes which are not involved with the change of the conduction state are formed in at least a part of the switch case which is opposed to the fixed electrodes, and

the through holes are filled with the protection portion.

The switch case may have a recess, the through holes may be formed within the recess, and the recess may be filled with the protection portion.

The switch case may have a first recess and a second recess, the through holes may include a first though hole and a second through hole, the first through hole may be formed within the first recess, the second through hole may be formed within the second recess, the protection portion may include a first protection portion and a second protection portion, the first protection portion may fill the first through hole and the first recess, and the second protection portion may fill the second through hole and the second recess.

The through holes may include a first through hole and a second through hole, the protection portion may include a first protection portion and a second protection portion, a surface of the first protection portion may be situated within the first through hole, and a surface of the second protection portion may be situated within the second through hole.

Each of the through holes may have an inner wall inclined so that a diameter thereof becomes smaller as more distant from the open edge of each of the through hole.

Each of the through holes may have an open edge having a diameter which is in a range of 0.1 mm to 0.3 mm.

The second resin may be resin which, before cured, has higher fluidity than the first resin.

The second resin may be ultraviolet curing resin.

### BRIEF DESCRIPTION OF DRAWINGS

FIG. 1 is an exploded perspective view of a push switch according to a first embodiment of the present invention.

FIGS. 2A to 2E are five-surface views of the push switch of FIG. 1.

FIGS. 3A to 3C are explanatory views of a method for manufacturing the push switch of FIG. 1.

FIGS. 4A and 4B are explanatory views of a method for manufacturing the push switch of FIG. 1.

FIGS. 5A and 5B are explanatory views of a method for manufacturing the push switch of FIG. 1.

FIGS. 6A to 6E are five-surface views of a push switch according to a second embodiment of the present invention.

FIGS. 7A to 7C are explanatory views of a method for manufacturing the push switch of FIGS. 6A to 6E.

FIG. 8 is an exploded perspective view of a push switch according to a third embodiment of the present invention.

FIGS. 9A to 9E are five-surface views of the push switch of FIG. 8.

FIGS. 10A and 10B are explanatory views of a method for manufacturing the push switch of FIG. 8.

### DETAILED DESCRIPTION OF EXEMPLIFIED EMBODIMENTS

Within the metal mold for molding the switch case, there are formed the multiple pins. The fixed electrodes are placed on the top portions of the pins, whereby they are situated at their specified positions. In this state, when resin is injected into the metal mold, the multiple fixed electrodes are molded integrally with the switch case. The pins are covered with the resin within the metal mold.

When the molded switch case is taken out from the metal mold, the pins are removed from the switch case, with the result that there are formed multiple holes in the switch case. The holes are respectively opened in the outer surface of the switch case and are extended to the bottom surfaces (the surfaces supported by the switch case) of the fixed electrodes.

In the step of molding the switch case integrally with the multiple fixed electrodes, the positioning thereof using the multiple pins is essential to obtain excellent switch operation characteristics. Therefore, so long as this manufacturing method is used, inevitably, there must be formed multiple through holes which penetrates through the switch case in such a manner that they are opposed to and communicate with the multiple fixed electrodes. Meanwhile, when water enters from these through holes opened in the outer surface of the switch case, there is a fear that the water can reach the fixed electrodes and thus can have ill influence on the performance of the switch. The inventors have got the idea that, by applying waterproofing measures to these through holes, the waterproof properties of the switch can be enhanced.

As the waterproofing measures, it is usually thought that the multiple through holes are covered with tape. However, in this case, since the through holes remain as they are, when the tape is damaged or peeled off, the waterproofing function is lost. It is an object of the invention to enhance the waterproof properties of such switch.

Description is given below specifically of embodiments of the invention with reference to the accompanying drawings. Here, in the respective drawings used in the following description, in order for the respective parts to have sizes capable of recognizing them, scale is changed properly. Also, expressions “front and rear”, “left and right” and “upper and lower” are used for convenience of explanation but they do not limit the attitudes or directions of the parts in actual use.

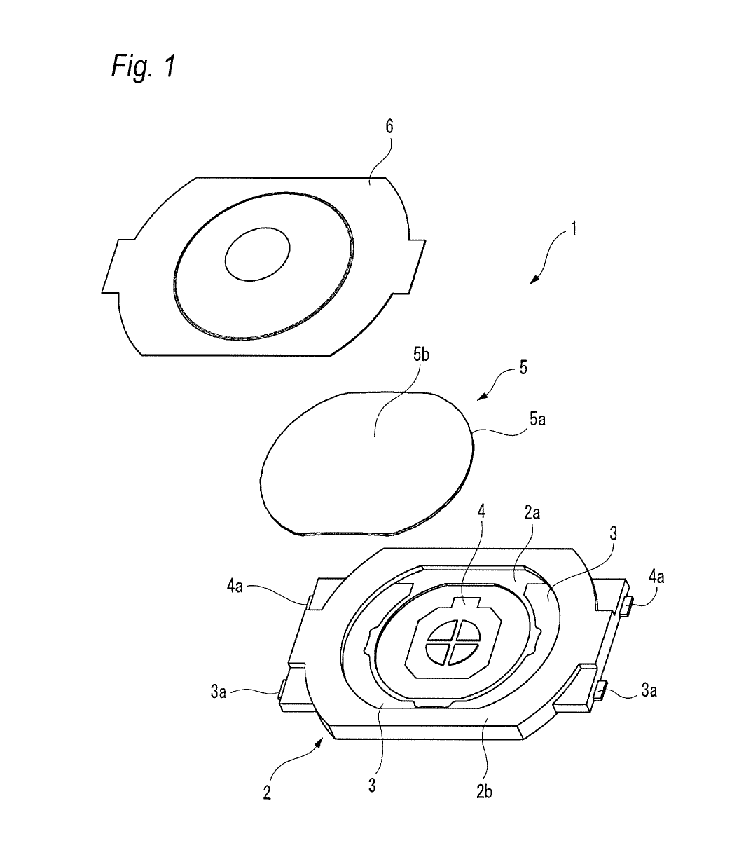

FIG. 1 is an exploded perspective view of the structure of a push switch 1 (an example of switches) according to a first embodiment. The push switch 1 includes a switch case 2, a first fixed electrode 3, a second fixed electrode 4, a movable electrode 5 and a pressing member 6.

The switch case 2 is made of insulating resin. Resin for forming the switch case 2 is called hereinafter first resin. The first resin includes liquid crystal polymer resin, nylon resin and the like. The switch case 2 has an upward-opened recess 2a.

The first and second fixed electrodes 3 and 4 are made of conductive material, are supported on the switch case 2, are exposed in the bottom of the recess 2a, and are partially embedded in the interior of the switch case 2, whereby they are separated and electrically insulated from each other.

The end portion 3a of the first fixed electrode 3 is exposed on the side surface of the switch case 2 and is used as a connecting terminal to an external circuit. The end portion 4a of the second fixed electrode 4 is exposed on the side surface of the switch case 2 and is used as a connecting terminal to an external circuit.

The movable electrode 5 is made of conductive material. The movable electrode 5 is an elastically deformable dome-shaped member, while it includes an outer edge portion 5a and a central portion 5b. The movable electrode 5 is stored into the recess 2a. In this case, the outer edge portion 5a is contacted with the first fixed electrode 3 and the central portion 5b is opposed to the second fixed electrode 4 with a clearance. That is, the movable electrode 5 is normally projected upward.

The pressing member 6 is mounted onto the upper surface 2b of the switch case 2 so as to cover the recess 2a. A user can press down the pressing member 6 directly or indirectly. When the pressing member 6 is depressed, the central portion 5b of the movable electrode 5 disposed below the pressing member 6 is pressed against the pressing member 6. When a load applied to the movable electrode 5 exceeds a given value, the central portion 5b is inverted with click feeling and is projected downward.

Thus, the central portion 5b and second fixed electrode 4 are contacted with each other, while the first and second fixed electrodes 3 and 4 are electrically connected through the movable electrode 5. That is, the movable electrode 5 changes the conduction state between the first and second fixed electrodes 3 and 4.

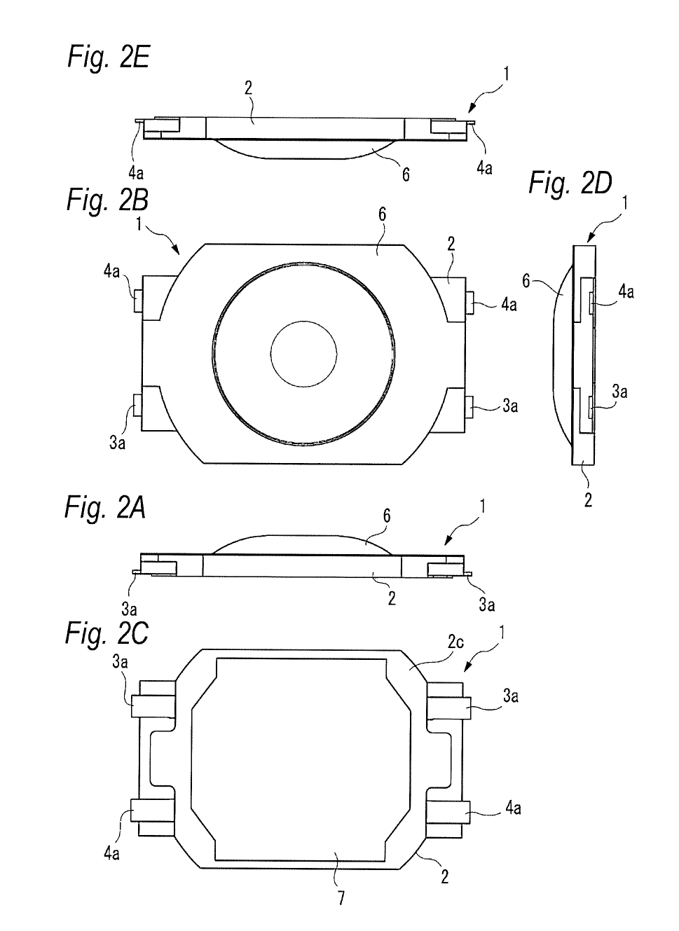

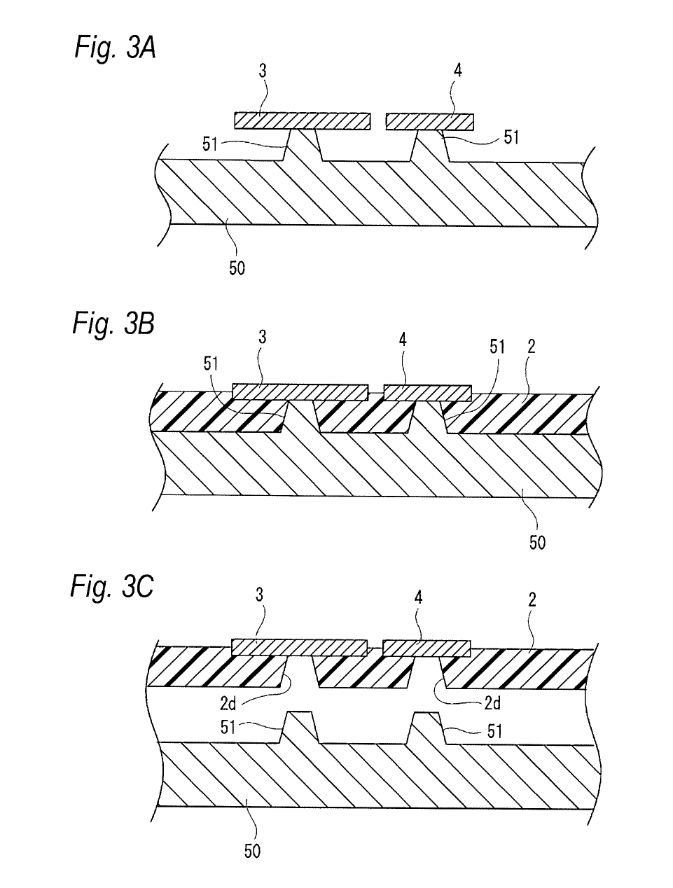

FIGS. 2A to 3E are five-surface views of the push switch 1 having the above structure. FIG. 2A is a front view, FIG. 2B is an upper view and FIG. 2C is a bottom view. FIG. 2D is a right side view. FIG. 2E is a back view. The shape thereof viewed from the left side surface is symmetric to the right side view and thus its illustration is omitted.

As shown in FIG. 2C, the switch case 2 includes a protection portion 7 on its bottom surface 2c. The protection portion 7 is formed of insulating resin. The resin for forming the protection portion 7 is hereinafter called second resin. The first and second resin may be the same or different.

Description is given of a method for manufacturing the thus-structured push switch 1 with reference to FIGS. 3A to 5B.

Firstly, as shown in FIG. 3A, a metal mold 50 for insert molding is prepared. The metal mold 50 includes multiple pins 51 therein. The first and second fixed electrodes 3 and 4 are partially disposed within the metal mold 50 and are supported by the top portions of the pins 51. This determines the positions of the first and second fixed electrodes 3 and 4.

Next, as shown in FIG. 3B, the first resin is injected into the metal mold 50. When the first resin is solidified, the switch case 2 is molded integrally with the first and second fixed electrodes 3 and 4.

Next, as shown in FIG. 3C, the molded switch case 2 is taken out from the metal mold 50 and the pins 51 are then removed from the switch case 2. As the traces of removal of the pins 51, there are formed multiple through holes 2d penetrating through the switch case 2 in such a manner that they are opposed to and communicate with the first and second fixed electrodes 3 and 4.

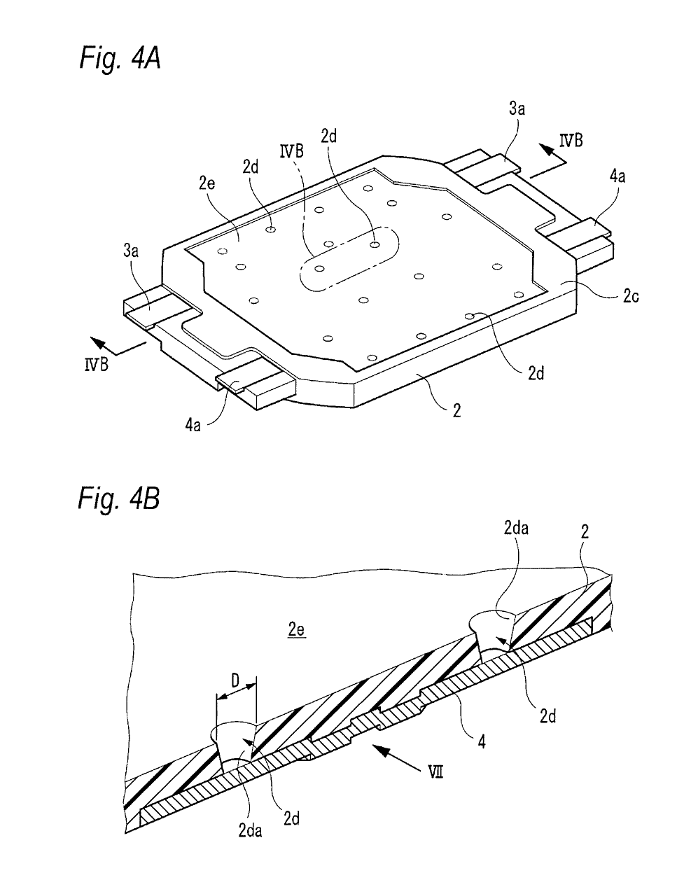

FIG. 4A is a perspective view of the appearance of the switch case 2 in this state, when viewed from the bottom surface 2c side. The switch case 2 includes the multiple through holes 2d which are respectively opened on the bottom surface 2c of the switch case 2. As described above, the through holes 2d are formed as the traces of removal of the pins 51 used to position the first and second fixed electrodes 3 and 4 in the switch case 2. Therefore, the through holes 2d are holes which are not involved with the change of the conduction state between the first and second fixed electrodes 3 and 4 caused by the operations of the movable electrode 5 and pressing member 6.

FIG. 4B enlargedly shows a portion (enclosed by the line IVB) of a section along the line IVB-IVB in FIG. 4A. The through holes 2d are formed at positions opposed to any one of the first and second fixed electrodes 3 and 4. In FIG. 4B, there are shown only the through holes 2d formed at positions opposed to the second fixed electrode 4. The diameters D of their open edges are in the range from 0.1 mm to 0.3 mm.

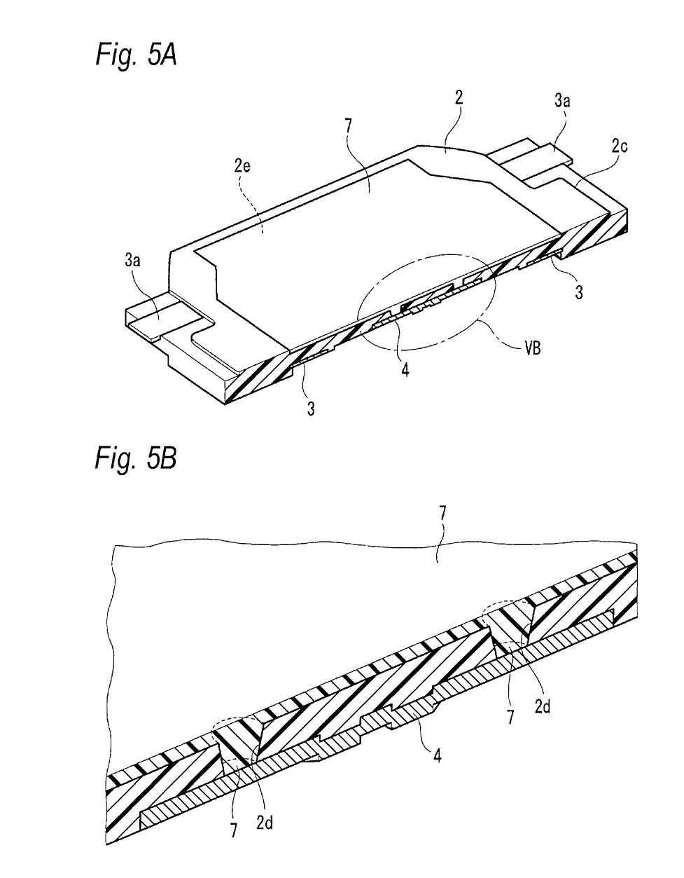

Next, as shown in FIG. 5A, the second resin is filled into the through holes 2d formed in the switch case 2 as the traces of removal of the pins 51. FIG. 5B enlargedly shows a portion enclosed by the line VB in FIG. 5A. When the second resin is cured, the protection portion 7 is formed. In this state, the through holes 2d are filled with the protection portion 7.

In a step of molding the switch case 2 integrally with the first and second fixed electrodes 3 and 4, the positioning thereof using the pins 51 is essential to obtain superior switch operation characteristics. Therefore, so long as such manufacturing method is used, through holes 2d must be unavoidably formed which penetrate through the switch case 2 so as to be opposed to and in communication with the first and second electrodes 3 and 4. However, they can be the entry pass of water.

As waterproofing measures, it is generally thought that the through holes 2d are covered with tape. However, in this case, since the through holes 2d remain as they are, when the tape is damaged or peeled off, the waterproof function is lost.

According to the push switch 1 of this embodiment, since the through holes 2d are filled with the second resin, a very highly sealed state can be obtained. As described above, the through holes 2d are not involved with the change of the conduction state between the first and second electrodes 3 and 4 caused by the operations of the movable electrode 5 and pressing member 6. Therefore, even when the through holes 2d are completely filled with the second resin, no ill influence is given on the operation of the push switch 1 itself. This can enhance the waterproof properties of the push switch 1 to be mounted onto electronic equipment.

Also, since the through holes 2d are voids, they can lower the rigidity of the switch case 2 into thermal deformation. However, according to the push switch 1 of this embodiment, since the through holes 2d are filled with the second resin and thus their voids are filled up, the rigidity of the switch case 2 is enhanced. This enhances the vibration- and impact-resistance of the switch case 2, there by being able to restrict the thermal deformation amount thereof. That is, the protection portion 7 formed as the waterproofing measures can also be used as a reinforcing member of the switch case 2.

As shown in FIG. 4A, the switch case 2 just after taken out from the metal mold 50 has a recess 2e in its bottom surface 2c. The through holes 2d are formed within the recess 2e. And, as shown in FIGS. 5A and 5B, the recess 2e is filled with the protection portion 7.

According to this structure, the second resin before cured can be stayed within the recess 2e, thereby being able to facilitate the flow thereof into the through holes 2d. This can enhance the waterproof properties of the push switch 1 to be mounted on the electronic equipment and also can enhance the rigidity of the switch case 2.

The second resin, before cured, may preferably have higher liquidity than the first resin. Such second resin includes liquid-state curing resin constituting of epoxy resin and ultraviolet curing resin.

In this case, injecting of the second resin into small-diameter through holes 2d can also be facilitated, thereby being able to fill the through holes 2d with the second resin positively. This can enhance the waterproof properties of the push switch 1 to be mounted on electronic equipment and also can enhance the rigidity of the switch case 2.

When ultraviolet curing resin is used as the second resin, by irradiating ultraviolet rays to the second resin to cure it, the protection portion 7 is formed.

In this case, without requiring additional metal mold facilities, the second resin can be easily cured to form the protection portion 7. Since the through holes 2d are sealed positively, the waterproof properties of the push switch 1 to be mounted on electronic equipment can be enhanced and also the rigidity of the switch case 2 can be enhanced.

Or, the protection portion 7 may also be formed through secondary molding. That is, the second resin may also be cured through secondary molding.

In this case, the connecting performance between the switch case 2 and protection portion 7 can be enhanced. The positive sealing of the through holes 2e can enhance the waterproof properties of the push switch 1 to be mounted on electronic equipment and also the rigidity of the switch case 2.

As shown in FIG. 4B, each of the through holes 2d includes an inner wall 2da inclined such that its diameter becomes smaller as it becomes more distant from the open edge of the hole.

According to this structure, the second resin before cured can be guided smoothly to the bottom portions of the through holes 2d. This can enhance the contact performance between the protection portion 7 to be formed and the first and second fixed electrodes 3, 4, thereby being able to further enhance the waterproof properties of the push switch 1 to be mounted on electronic equipment.

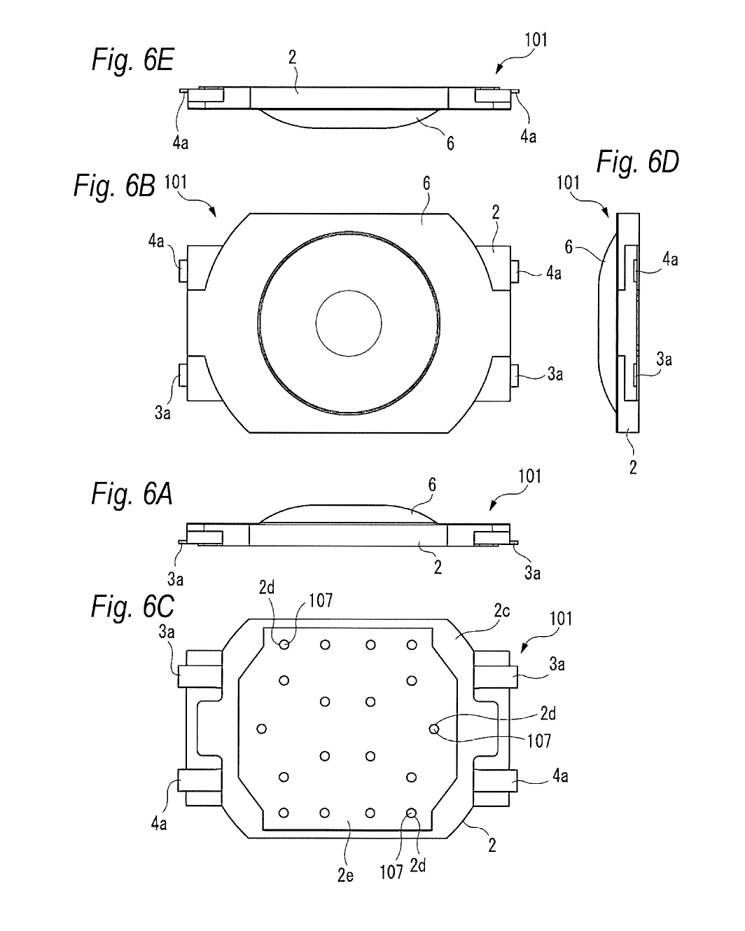

FIGS. 6A to 6E are five-surface views of a push switch 101 (an example of switches) according to a second embodiment. FIG. 6A is a front view. FIG. 6B is a top view. FIG. 6C is a bottom view. FIG. 6D is a right side view. FIG. 6E is a back view. The shape of the switch viewed from the left side surface is symmetric with that of the right side view and thus the illustration thereof is omitted. Composing elements used in this embodiment, which are the same or equivalent to those of the push switch 1 of the first embodiment, are given the same reference numerals. The repetitive description thereof is omitted.

As shown in FIG. 6C, the recess 2e of the switch case 2 includes multiple through holes 2d within which there are formed protection portions 107 respectively. The protection portion 107 is formed of the second resin. The second resin may also be the same as or different from the first resin. That is, the push switch 101 includes the multiple protection portions 107. The protection portions 107 are formed within their associated through holes 2d respectively and thus they are independent of each other. The diameter D of the open edge of each through hole 2d is in the range of 0.1 mm to 0.3 mm.

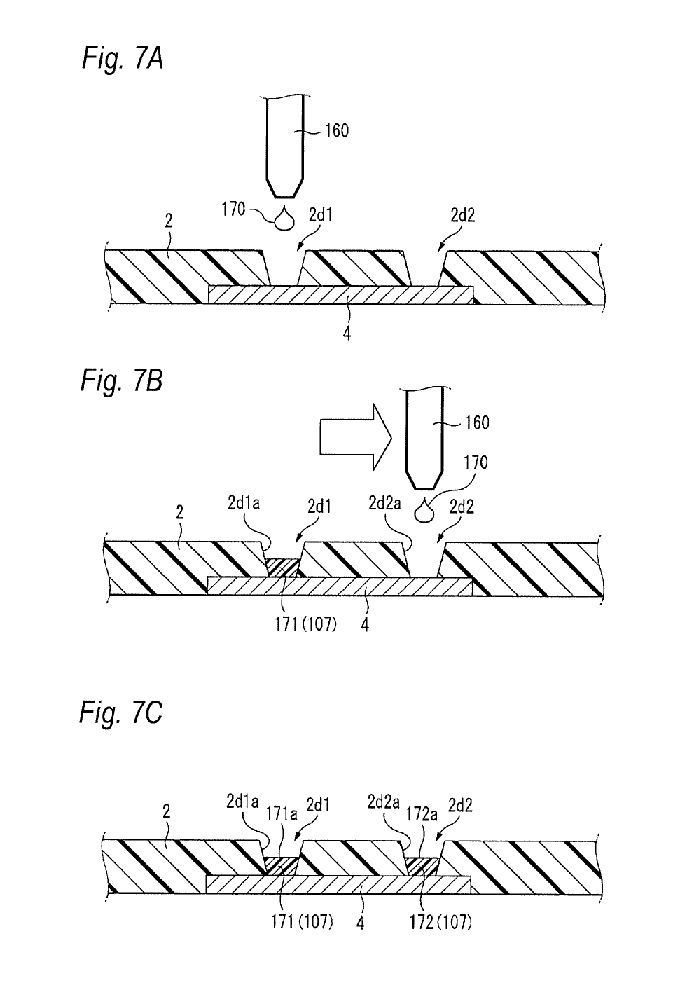

Referring to FIGS. 7A to 7C, description is given of a method for manufacturing the push switch 101 having this structure. The step described in the first embodiment with reference to FIGS. 3A to 4B is also applied to this embodiment.

FIG. 7A shows typically the state of a section shown in FIG. 4B when viewed from the direction of the arrow VII. Next, as shown in FIG. 7A, a nozzle 160 is disposed opposed to one (first through hole 2d1) of the through holes 2d formed in the switch case 2 as the traces of removal of the pins 51. The nozzle 160 has a structure capable of injecting liquid resin using a so called ink jet technology.

Next, liquid-state second resin 170 is injected from the nozzle 160 toward its opposed first through hole 2d1. As shown in FIG. 7B, the liquid-state second resin 170 is contacted with the second fixed electrode 4 within the first through hole 2d1. Next, as shown in FIG. 7C, the liquid-state second resin 170 is cured within the first through hole 2d1, thereby forming one (first protection portion 171) of the protection portions 107. The first protection portion 171 sticks to the first inner wall 2d1a of the first through hole 2d1 and covers its opposed second fixed electrode 4.

As shown in FIGS. 7A and 7B, the nozzle 160 having injected the liquid-state second resin 170 toward the first through hole 2d1 is disposed opposed to another one (second through hole 2d2) of the through holes 2d. Similarly, the liquid-state second resin 170 is injected to the second through hole 2d2 and is cured therein, thereby forming another one (second protection portion 172) of the protection portions 107 within the second protection portion 172. The second protection portion 172 sticks to the second inner wall 2d2a of the second through hole 2d2 and covers its opposed second fixed electrode 4.

In a step of forming the switch case 2 integrally with the first and second fixed electrodes 3 and 4, the positioning thereof using the pins 51 is essential in order to obtain excellent switch operation characteristics. So long as such manufacturing method is used, it is inevitable to form the multiple through holes 2d respectively penetrating the switch case 2 in such a manner that they are opposed to and communicate with the first and second fixed electrodes 3 and 4. However, these through holes 2d can provide passages through which water intrudes.

As the waterproof measures, it is usually thought to cover the through holes 2d with tape. However, in this case, since the through holes 2d remain as they are, when the tape is damaged or peeled off, the waterproof function is lost.

In the push switch 101 of this embodiment, the protection portions 107 made of the second resin are formed within their respective through holes 2d. Since the protection portions 107, while sticking to the inner walls of the through holes 2d, cover their opposed first and second fixed electrodes 3 and 4, there can be obtained a very highly sealed state. Also, since the protection portions 107 are formed within their respective through holes 2d, an external force is hard to be applied to them, thereby being able to restrict a fear of peel-off or damage. This can enhance the waterproof performance of the push switch 101 to be mounted on electronic equipment. Here, as described above, the through holes 2d are not involved with the change of the conduction state between the first and second fixed electrodes 3 and 4 caused by the operations of the movable electrode 5 and pressing member 6. Therefore, even when the protection portions 107 are formed within their associated through holes 2d, such formation does not have any ill influence on the operation of the push switch 101 itself.

Also, since the through holes 2d are voids, they can provide a factor for lowering the rigidity of the switch case 2 into thermal deformation. However, according to the above structure, since the protection portions 107 made of the second resin are formed within the through holes 2d, the rigidity of the switch case 2 is enhanced, thereby being able to enhance the vibration- and shock-resistant performance of the switch case 2 and thus to restrict the amount of thermal deformation thereof. That is, the protection portions 107 formed as the waterproof measures can also be used as the reinforcing member of the switch case 2.

The amount of the liquid-state second resin 170 to be injected from the nozzle 160 is determined such that the surfaces of the protection portions 107 to be formed are situated within the through holes 2d. For example, as shown in FIG. 7C, the surface 171a of the first protection portion 171 is situated within the first through hole 2d1. Similarly, the surface 172a of the second protection portion 172 is situated within the second through hole 2d2.

According to this structure, when compared with a structure that resin is filled into the whole of the recess 2e to close the through holes 2d, the amount of the second resin for forming the protection portions 107 can be reduced. Therefore, while restricting the material cost, the waterproof performance of the push switch 101 to be mounted on electronic equipment can be enhanced.

As shown in FIG. 7B, the first through hole 2d1 has a first inner wall 2d1a inclined such that its diameter reduces as it becomes distant from its open edge. Similarly, the second through hole 2d2 has a second inner wall 2d2a inclined such that its diameter reduces as it becomes distant from its open edge.

According to this structure, the liquid-state second resin 170 injected from the nozzle 160 can be guided smoothly to the bottom portions of the through holes 2d. This can further enhance the waterproof performance of the push switch 101 to be mounted on electronic equipment.

The second resin, before cure, may preferably have higher liquidity than the first resin before cured. Such second resin includes, for example, liquid-state curing resin formed of epoxy resin and ultraviolet curing resin.

In this case, the injecting of the liquid-state second resin 170 even into the through holes 2d of a small diameter can be facilitated. This enhances the contact performance between the protection portions 107 to be formed and first and second fixed electrodes 3 and 4, thereby being able to enhance the waterproof performance of the push switch 101 to be mounted on electronic equipment.

In the case that ultraviolet curing resin is used as the second resin, when it is irradiated to the liquid-state second resin 170 and is cured, the protection portions 107 is formed.

In this case, without requiring additional metal mold facilities, the liquid-state second resin 170 can be cured easily to form the protection portions 107. Therefore, while reducing the manufacturing cost, the waterproof performance of the push switch 101 to be mounted on electronic equipment can be enhanced.

In this embodiment, the switch case 2 has the recess 2e, within which the multiple through holes 2d are formed. However, the switch case 2 needs not always have the recess 2e. For example, the surface for opening up the multiple through holes 2d therein may be the bottom surface 2c of the switch case 2. In this case, the thickness dimension of the switch case 2 can be reduced.

In this embodiment, after the liquid-state second resin 170 is injected toward the first through hole 2d1 from the nozzle 160, the nozzle 160 is moved to a position opposed to the second through hole 2d2. However, change of relative positions between the nozzle 160 and through holes 2d may be made by displacing at least one of the nozzle 160 and switch case 2. Also, by using multiple nozzles 160 respectively opposed to the first and second through holes 2d1 and 2d2, the injection of the liquid-state second resin 170 to the first through hole 2d1 and the injection of the liquid-state second resin 170 to the second through hole 2d2 may also be carried out simultaneously. The number of nozzles 160 used can be determined properly according to the number of multiple through holes 2d.

In the case of ultraviolet curing resin, the respective steps may also be executed by the following procedure: 1) the liquid-state second resin 170 is injected toward the first through hole 2d1 from the nozzle 160; 2) the second resin 170 of the first through hole 2d1 is cured to form the first protection portion 171; 3) the liquid-state second resin 170 is injected toward the second through hole 2d2 from the nozzle 160; and, 4) the second resin 170 of the second through hole 2d2 is cured to form the second protection portion 172. Or, the steps may also be executed by the following procedure: 1) the liquid-state second resin 170 is injected to the first and second through holes 2d1 and 2d2 (simultaneously or sequentially); 2) the liquid-state second resin 170 in the first and second through holes 2d1 and 2d2 is cured to form the first and second protection portions 171 and 172 (simultaneously or sequentially).

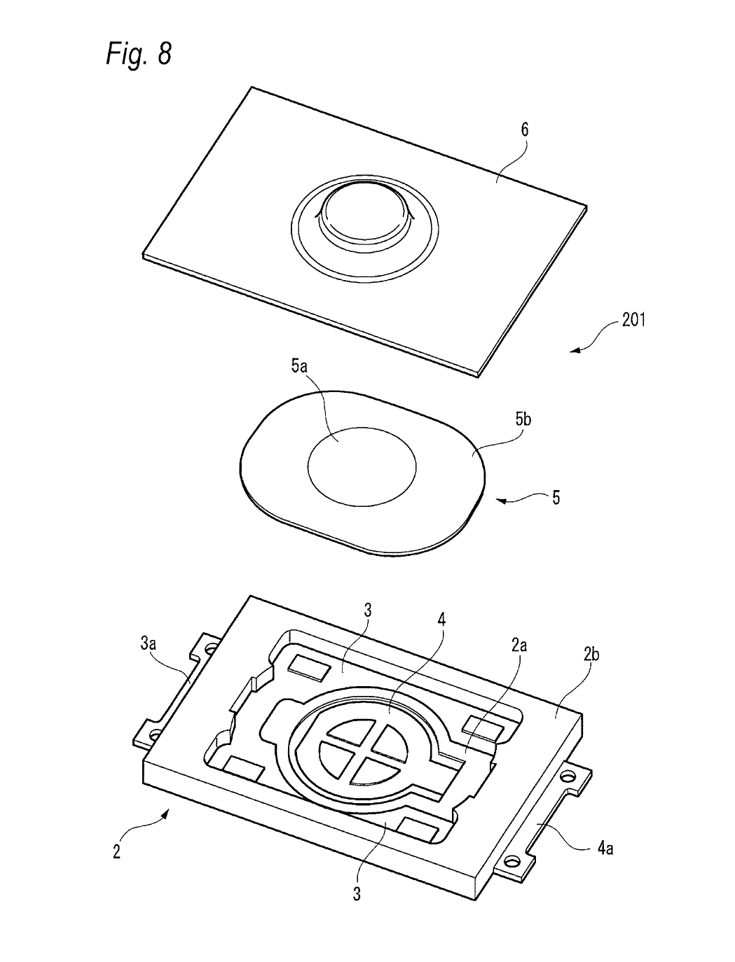

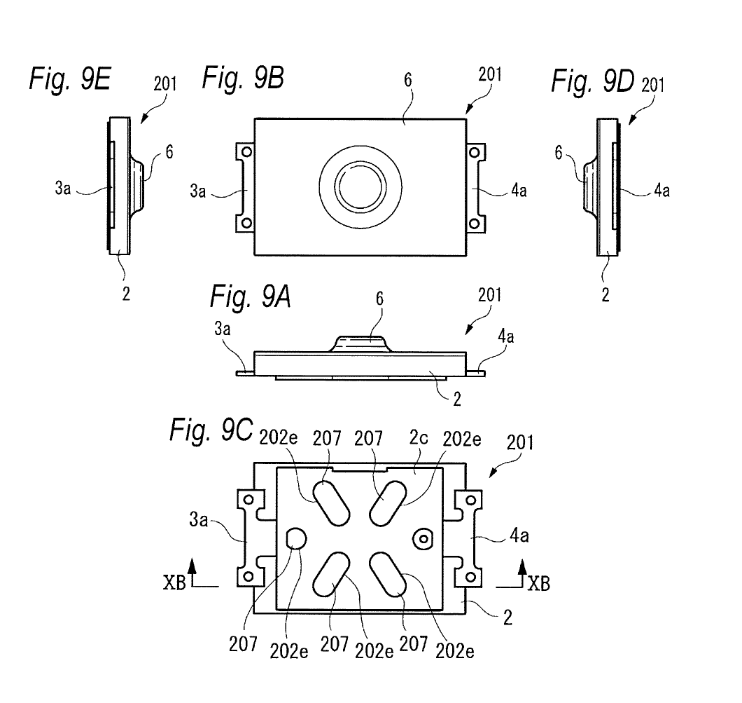

FIG. 8 is an exploded perspective view of the structure of a push switch 201 (an example of switches) according to a third embodiment. FIGS. 9A to 9E are five-surface views of the push switch 201. FIG. 9A is a front view. FIG. 9B is a top view. FIG. 9C is a bottom view. FIG. 9D is a right side view. FIG. 9E is a left side view. A back view is symmetric with the front view and thus the illustration thereof is omitted. Composing elements having equivalent or same structures and functions as those of the push switch 1 of the first embodiment are given the same reference numerals. The repeated description of such composing elements is omitted.

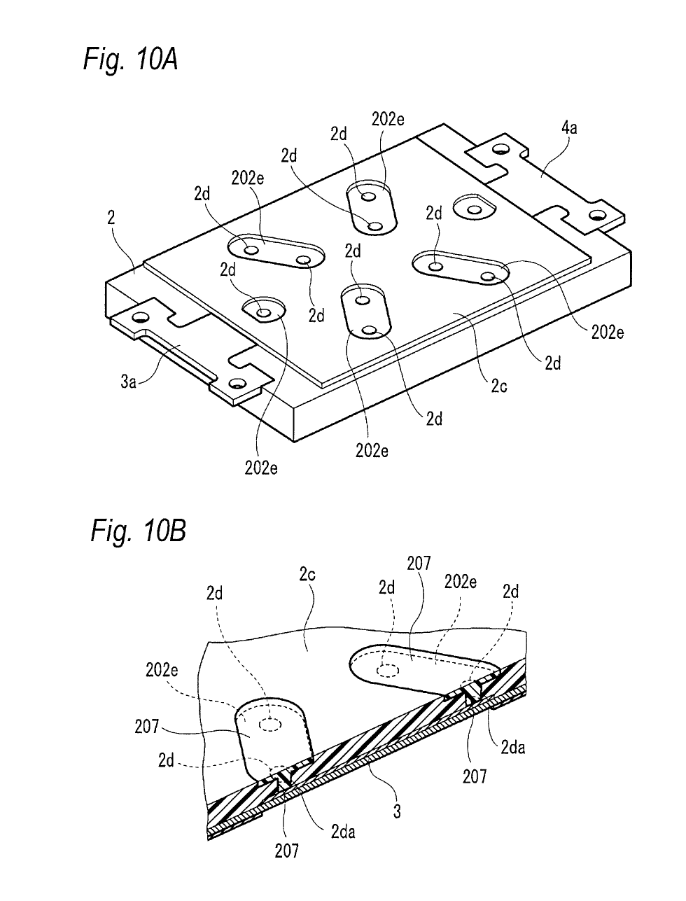

As shown in FIG. 10A, in the bottom surface 2c of the switch case 2 just after it is taken out from the metal mold 50 described with reference to FIGS. 3A to 3C, there are formed multiple recesses 202e. FIG. 10B is a partially enlarged view of the section of the switch case 2 taken along the line XB-XB of FIG. 9C. As shown in FIG. 10B, the recesses 202e are respectively filled with the protection portions 207. That is, the push switch 201 has the multiple protection portions 207. The protection portions 207 are respectively formed of the second resin. The second resin may be the same as or different from the first resin.

Each of the recesses 202e has at least one through hole 2d. That is, the push switch 201 has multiple through holes 2d. One (an example of the first protection portions) of the protection portions 207 fills one (an example of the first recesses) of the recesses 202e and at least one through hole 2d (an example of the first through holes). Another one (an example of the second protection portions) of the protection portions 207 fills one (an example of the second recesses) of the recesses 202e and at least one through hole 2d (an example of the second through holes).

The protection portion 207 can also be formed either by the method for forming the protection portion 7 according to the first embodiment described with reference to FIGS. 3A to 5B, or by the method for forming the protection portion 107 according to the second embodiment described with reference to FIGS. 3A to 4B and 7A to 7C.

In the step of molding the switch case 2 integrally with the first and second fixed electrodes 3 and 4, the positioning thereof using the pins 51 is essential in order to obtain excellent switch operation characteristics. So long as this manufacturing method is used, it is inevitable to form the multiple through holes 2d respectively penetrating the switch case 2 in such a manner that they are opposed to and communicate with the first and second fixed electrodes 3 and 4. However, these through holes 2d can provide passages through which water intrudes.

As the waterproof measures, it is usually thought to cover the through holes 2d with tape. However, in this case, since the through holes 2d remain as they are, when the tape is damaged or peeled off, the waterproof function is lost.

According to the push switch 201 of this embodiment, since the through holes 2d are filled with the second resin, there can be obtained a very highly sealed state. As described above, the through holes 2d are not involved with the change of the electric connection state between the first and second fixed electrodes 3 and 4 caused by the operations of the movable electrode 5 and pressing member 6. Therefore, even when the through holes 2d are completely filled with the second resin, such complete filling has no ill influence on the operation of the push switch 201 itself. This can enhance the waterproof performance of the push switch 201 to be mounted on electronic equipment.

Also, since the through holes 2d are voids, they can provide a factor for lowering the rigidity of the switch case 2 into thermal deformation. However, according to the push switch 201 of this embodiment, since the protection portions 107 made of the second resin are formed within the through holes 2d, the rigidity of the switch case 2 is enhanced, thereby being able to enhance the vibration- and shock-resistant performance of the switch case 2 and thus to restrict the amount of thermal deformation thereof. That is, the protection portions 207 formed as the waterproof measures can also be used as the reinforcing member of the switch case 2.

As shown in FIG. 10A, the switch case 2 just after it is taken out from the metal mold 50 has multiple recesses 202e in its bottom surface 2c. Each of the recesses 202e has at least one through hole 2d. And, as shown in FIG. 10B, each of the protection portions 207 formed of the second resin fills its corresponding one of the recesses 202e and at least one through hole 2d formed in this recess 202e.

According to this structure, the second resin before cured can be stored in the recesses 202e, thereby being able to facilitate the injecting thereof into the through holes 2d formed in the recesses 202e. This enables the through holes 2d to be positively filled with the second resin. This can enhance the waterproof performance of the push switch 201 to be mounted on electronic equipment and also can enhance the rigidity of the switch case 2. Also, the recesses 202e are formed locally in the bottom surface 2c of the switch case 2 such that they respectively have a size capable of enclosing at least one through hole 2d. Therefore, when compared with the push switch 1 of the first embodiment where the recesses 2e are formed nearly on the whole of the bottom surface 2c, the amount of the second resin for forming the protection portions 207 can be reduced and thus the material cost can be restricted.

The second resin, before cured, may preferably have higher fluidity than the first resin. Such second resin includes liquid-state curing resin constituted of epoxy resin and ultraviolet curing resin.

In this case, the injecting of the second resin even into the through hole 2d of a small diameter can be facilitated. This enables the through holes 2d to be positively filled with the second resin. This can enhance the waterproof performance of the push switch 201 to be mounted on electronic equipment and also can enhance the rigidity of the switch case 2.

In the case that ultraviolet curing resin is used as the second resin, when ultraviolet rays are irradiated to the second resin to cure it, the protection portions 207 are formed.

In this case, without requiring additional metal mold facilities, the second resin can be easily cured to form the protection portions 207 and thus seal the through holes 2d positively. Such positive sealing can enhance the waterproof performance of the push switch 201 to be mounted on electronic equipment and also can enhance the rigidity of the switch case 2.

Or, the protection portions 207 may also be formed by secondary molding. That is, the second resin may also be cured through secondary molding.

In this case, the connecting performance between the switch case 2 and protection portions 207 can be enhanced. Since the through holes 2d are sealed positively, the waterproof property of the push switch 201 to be mounted on electronic equipment can be enhanced and the rigidity of the switch case 2 can also be enhanced.

As shown in FIG. 10B, each of the through holes 2d has an inner wall 2da inclined such that its diameter reduces as it becomes distant from its open edge.

According to this structure, the before-cured second resin can be guided smoothly to the bottom portions of the through holes 2d. This can enhance the contact performance between the protection portions 207 to be formed and the first and second fixed electrodes 3, 4, thereby being able to further enhance the waterproof properties of the push switch 201 to be mounted on electronic equipment.

The above embodiments are just examples which facilitate the understanding of the invention. The structures of the above embodiments can be changed or improved properly without departing from the subject matter of the invention. Also, it is obvious that equivalents also fall within the technical scope of the invention.

In the above description, as a switch according to the invention, there is illustrated a push switch. However, the invention can also be applied to other type of switch such as a slide switch so long as it includes multiple fixed electrodes supported by the switch case and a movable electrode for changing the conduction state between the fixed electrodes.

According to the present invention, since the through holes are filled with the second resin, a very highly sealed state can be obtained. The through holes are not involved with the change of the conduction between the fixed electrodes caused by the operation of the movable electrode. Therefore, even when the through holes are completely filled with the second resin, they have no bad influence on the operation of the switch itself. This can enhance the waterproof properties of a switch to be mounted on electronic equipment.

Also, since the through holes are voids, they can provide a factor for reducing the rigidity of the switch case into thermal deformation. However, according to the above structure, since the through holes are filled with the second resin and thus the voids are also filled, the rigidity of the switch case is enhanced. This can enhance the vibration- and shock-resistant performance of the switch case and thus can restrict the amount of the thermal deformation thereof. That is, the protection portion formed as the waterproofing measures can also be used as the reinforcing member of the switch case.

According to the manufacturing method of the present invention, when compared with a method in which through holes are closed by filling resin so as to cover the whole of the openings of the through holes, the amount of the second resin used to form the protection portion can be reduced. Thus, while reducing the material cost, the waterproof properties of a switch to be mounted on electronic equipment can be enhanced.

Further, According to the present invention, the before-cured second resin can be stayed within the recess, thereby being able to facilitate the injecting thereof into the through holes. Thus, the through holes can be positively filled with the second resin. This can enhance the waterproof properties of a switch to be mounted on electronic equipment and also can enhance the rigidity of the switch case.

Also, according to the structure according to the present invention, the before-cured second resin can be stayed within the recess, thereby being able to facilitate the injecting thereof into the through holes. Thus, the through holes can be positively filled with the second resin. This can enhance the waterproof properties of a switch to be mounted on electronic equipment and also can enhance the rigidity of the switch case. Further, each of the recesses can be formed locally such that it has a size capable of surrounding at least one through hole. This can reduce the amount of the second resin for forming the protection portions and thus can reduce the material cost.

Further, the before-cured second resin can be guided smoothly to the bottom portions of the through holes. This can enhance the contact performance between the protection portion to be formed and fixed electrode opposed thereto, thereby being able to further enhance the waterproof properties of a switch to be mounted on electronic equipment.

In the present invention, the second resin can be more easily poured into the penetration of a small diameter. This can enhance the contact performance between the protection portion to be formed and fixed electrode opposed thereto, thereby being able to further enhance the waterproof properties of a switch to be mounted on electronic equipment.

Further, without requiring additional metal mold facilities, the second resin can be easily cured to form the protection portion. Thus, while reducing the manufacturing cost, the waterproof properties of a switch to be mounted on electronic equipment can be enhanced.

Further, the connecting performance between the switch case and protection portion can be enhanced, thereby being able to seal the through holes positively. This can enhance the waterproof properties of a switch to be mounted on electronic equipment and also can enhance the rigidity of the switch case.

According to the invention, the waterproof properties of a switch to be mounted on electronic equipment can be enhanced.

What is claimed is:

1. A manufacturing method for a switch, comprising steps of:
arranging a plurality of fixed electrodes so as to be supported by a plurality of pins provided within a metal mold;
molding a switch case integrally with the fixed electrodes by injecting a first resin into the metal mold;
pulling out the pins to take out the switch case from the metal mold;
filling a liquid-state second resin into through holes formed in the switch case as traces of removal of the pins; and
curing the liquid-state second resin to form a protection portion.

2. The manufacturing method according to claim 1, wherein
the liquid-state second resin is injected from a nozzle toward the through holes, and
the liquid-state second resin is cured within each of the through holes to form the protection portion.

3. The manufacturing method according to claim 2, wherein
an amount of injection of the liquid-state second resin is determined so that a surface of the protection portion to be formed is situated within each of the through holes.

4. The manufacturing method according to claim 1, wherein
the second resin is ultraviolet curing resin which is cured by irradiating ultraviolet rays thereto.

5. The manufacturing method according to claim 1, wherein
the second resin is cured through secondary molding.

6. The manufacturing method according to claim 1, wherein
the second resin is resin which, before cured, has higher fluidity than the first resin.

7. A switch, comprising:
a switch case formed of a first resin;
a plurality of fixed electrodes supported by the switch case;
a movable electrode configured to change a conduction state between the fixed electrodes; and
a protection portion formed of a second resin,
wherein a plurality of through holes which are not involved with the change of the conduction state are formed in at least a part of the switch case which is opposed to the fixed electrodes, and
the through holes are filled with the protection portion.

8. The switch according to claim 7, wherein
the switch case has a recess,
the through holes are formed within the recess, and
the recess is filled with the protection portion.

9. The switch according to claim 7, wherein
the switch case has a first recess and a second recess,
the through holes include a first though hole and a second through hole,
the first through hole is formed within the first recess,
the second through hole is formed within the second recess,
the protection portion includes a first protection portion and a second protection portion,
the first protection portion fills the first through hole and the first recess, and
the second protection portion fills the second through hole and the second recess.

10. The switch according to claim 7, wherein
the through holes includes a first through hole and a second through hole,
the protection portion includes a first protection portion and a second protection portion,
a surface of the first protection portion is situated within the first through hole, and
a surface of the second protection portion is situated within the second through hole.

11. The switch according to claim 7, wherein
each of the through holes has an inner wall inclined so that a diameter thereof becomes smaller as more distant from the open edge of each of the through hole.

12. The switch according to claim 7, wherein
each of the through holes has an open edge having a diameter which is in a range of 0.1 mm to 0.3 mm.

13. The switch according to claim 7, wherein
the second resin is resin which, before cured, has higher fluidity than the first resin.

14. The switch according to claim 7, wherein
the second resin is ultraviolet curing resin.
